(19) United States
(12) Patent Application Publication
(10) Pub. No.: US 2016/0378303 A1
(43) Pub. Date: Dec. 29, 2016

(54) MOBILE DEVICE SYSTEM FOR HAILING A TAXI CAB

(71) Applicant: Todd Crilley, Lake Station, IN (US)

(72) Inventor: Todd Crilley, Lake Station, IN (US)

(21) Appl. No.: 14/747,097

(22) Filed: Jun. 23, 2015

(51) Int. Cl. G06F 3/0484; G06F 3/01; G06F 3/16; G06T 13/80

(52) U.S. Cl. CPC G06F 3/04842; G06T 13/80; G06F 3/017; G06F 3/167

(57) ABSTRACT

A mobile device for hailing a taxi cab includes one or more processors, a memory, a graphical user interface (GUI) display, and a speaker device. The mobile device downloads an application including embedded content and code. The mobile device receives a first input from a user to activate the application. Responsive to receiving the first input, the mobile device activates the application to (a) display a selectable graphic on the GUI display, (b) receive a second input from a user selecting the selectable graphic, and (c) responsive to receiving the second input, display on the GUI display, an animation graphic configured to alert the taxi cab.

### BACKGROUND

As it stands today, hailing a taxi cab is an inefficient proposition at best and a risky proposition at worst. Where visibility is an issue, such as at night, on a crowded street, during rainy or cloudy days, or other such conditions, individuals attempting to catch the attention of a taxi cab run the risk of harm caused by passing traffic. Moreover such individuals cause increased traffic congestion in their often unsuccessful attempts to call a taxi.

Prior art illuminating devices have been large and bulky devices that a user is required to carry around while he or she is outside in order for any benefit to accrue. Due to their burdensome nature, such prior art devices have largely been commercially unsuccessful. Moreover, these devices have offered little to nothing in the way of customization. As such, these devices have been unable to adapt to an individual user's needs at a particular time. The present disclosure presents a different technological approach to the manner in which taxi cabs are hailed.

### SUMMARY

The present disclosure provides a new and innovative systems, methods and computer readable media for hailing a taxi cab using a mobile device.

A system includes an application server and a mobile device, including one or more processors, a memory, a graphical user interface (GUI) display, and a speaker device, to transmit a request for an application including embedded content and code. The application server transmits the requested application to the mobile device. The mobile device downloads the application. The mobile device then receives a first input from a user to activate the application. Responsive to receiving this first input, the mobile device activates the application to (a) display a selectable graphic on the GUI display, (b) receive a second input from a user selecting the selectable graphic, and (c) responsive to receiving the second input, display on the GUI display, an animation graphic configured to alert a taxi cab.

A mobile device includes one or more processors, a memory, a graphical user interface (GUI) display, and a speaker device, executing instructions to download an application including embedded content and code. The mobile device receives a first input from a user to activate the application. Responsive to receiving the first input, the mobile device activates the application to (a) display a selectable graphic on the GUI display, (b) receive a second input from a user selecting the selectable graphic, and (c) responsive to receiving the second input, display on the GUI display, an animation graphic configured to alert a taxi cab.

An application server includes one or more processors and a memory, and provides an application for hailing a taxi cab. When the application is executed by a mobile device, it causes the mobile device to (a) display a selectable graphic on the GUI display, (b) receive a second input from a user selecting the selectable graphic, and (c) responsive to receiving the second input, display on the GUI display, an animation graphic configured to alert a taxi cab.

Additional features and advantages of the disclosed method and apparatus are described in, and will be apparent from, the following Detailed Description and the Figures.

### BRIEF DESCRIPTION OF THE FIGURES

FIG. 1 is a block diagram of an example system including an application server and a mobile device according to an example embodiment of the present disclosure.

FIG. 2 is a series of screenshots of a mobile device according to an example embodiment of the present disclosure.

FIG. 3 is a series of screenshots of a mobile device according to another example embodiment of the present disclosure.

FIG. 4 is a flowchart illustrating an example process for hailing a taxi cab according to an example embodiment of the present disclosure.

FIG. 5 is a flowchart illustrating an example process for hailing a taxi cab according to another example embodiment of the present disclosure.

FIG. 6 is a flow diagram illustrating an example process for hailing a taxi cab according to an example embodiment of the present disclosure.

### DETAILED DESCRIPTION OF EXAMPLE EMBODIMENTS

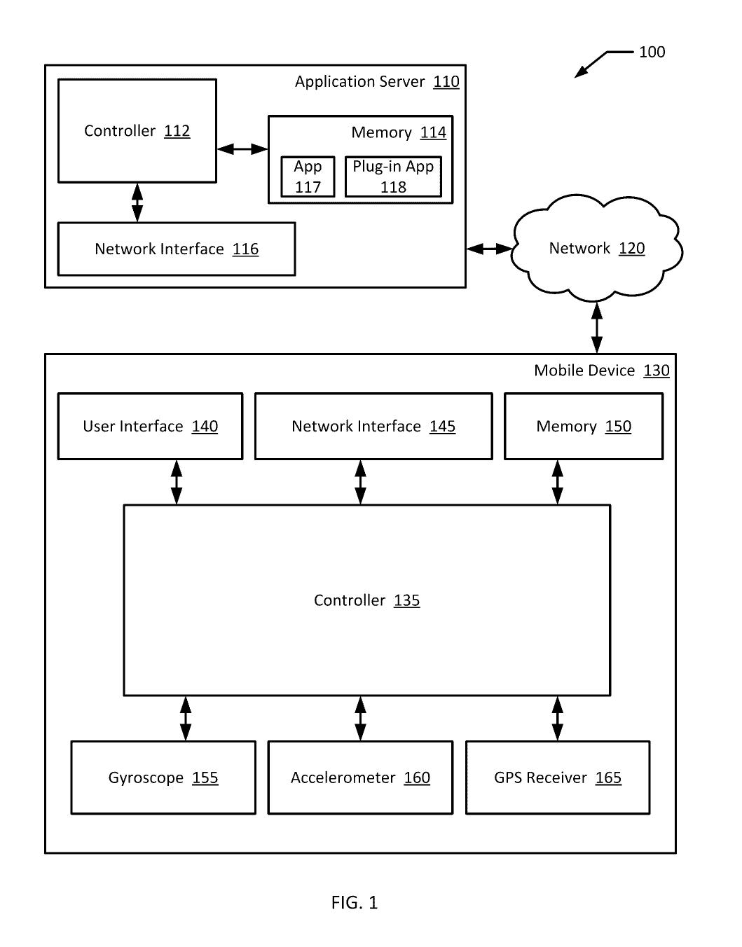

FIG. 1 depicts a high-level component diagram of an example system 100 in accordance with one or more aspects of the present disclosure. The system 100 may include an application server 110 connected to a mobile device 130 via a network 120.

For example, the network 120 may be any communications network for transporting data between senders and receivers including the Internet, intranet, local area network (LAN), wide area network (WAN) (such as frame relay and asynchronous transfer mode (ATM), virtual private network (VPN), public switched telephone network (PSTN)), enterprise service bus (ESB), wireless personal area network (WPAN) (such as Bluetooth and near field communication (NFC)), wireless local area network (WLAN) (such as Wi-Fi), wireless wide area network (WWAN), wireless metropolitan area network (WMAN), long term evolution (LTE), cellular network such as global system for mobile communication (GSM), general packet radio service (GPRS), code division multiple access (CDMA), evolution-data optimized (EV-DO), enhanced data rates for GSM evolution (EDGE), digital enhanced cordless telecommunication (DECT), integrated digital enhanced network (IDEN), or any combination thereof.

In an example embodiment, an application server 110 may include a controller 112 communicatively coupled to memory 114 and a network interface 116. The memory 117 may store an application 117 and/or a plug-in application 118. In an example embodiment, application server 110 may be in communication with one or more databases that store application 117 and/or plug-in application 118 as well as various items of data related to the provisioning of applications to mobile devices. In an example embodiment, a mobile device 130 may include a controller 135 communicatively coupled to a user interface 140, a network interface 145, a memory 150, a gyroscope 155, an accelerometer 160, and a global positioning sensor (GPS) receiver 165. For example, a mobile device may be a mobile phone, a smartphone, a tablet computer, a handheld computing device, or the like.

As used herein, a controller (e.g., controller 112 or controller 135) is a device capable of executing instructions encoding arithmetic, logical, and/or I/O operations. In one illustrative example, a controller may follow Von Neumann architectural model and may include an arithmetic logic unit (ALU), a control unit, and a plurality of registers. In a further aspect, a controller may be a single core controller which is typically capable of executing one instruction at a time (or process a single pipeline of instructions), or a multi-core controller which may simultaneously execute multiple instructions. In another aspect, a controller may be implemented as a single integrated circuit, two or more integrated circuits, or may be a component of a multi-chip module (e.g., in which individual microprocessor dies are included in a single integrated circuit package and hence share a single socket). A controller may also be referred to as a central processing unit (CPU), processor, microprocessor, microcontroller, or multi-processor.

As described herein, a memory (e.g., memory 114 or memory 150) refers to any device capable of storing data (including programs or files) such as RAM, ROM, or EEPROM. As used herein, a network interface (e.g., network interface 116 or network interface 145) refers to any module for sending and receiving data to and from other devices over the network 120 using a variety of known protocols (e.g., a network interface controller (NIC), a network adapter, etc.).

In an example embodiment, the user interface 140 of the mobile device 130 facilitates the transfer of data into the mobile device 130 via an input device such as a touch screen, keyboard, keypad, touch-pad, mouse, stylus, microphone, camera, sensor, etc. Similarly, the user interface 140 may facilitate the transfer of data from the mobile device via an output device such as a screen, display, speaker, etc. A touch screen interface, for example, can serve as both an input and output device by detecting physical contact from a user of the mobile device 130 and generating an event. For example, if a user desires to launch an application 117, the user may touch the icon of the application 117 shown on the display of the mobile device 130.

One of ordinary skill in the art would understand that the descriptions of the application server 110 and the mobile device 130 are provided by way of example only and that these modules may include additional or fewer components without detracting from the scope of the present disclosure.

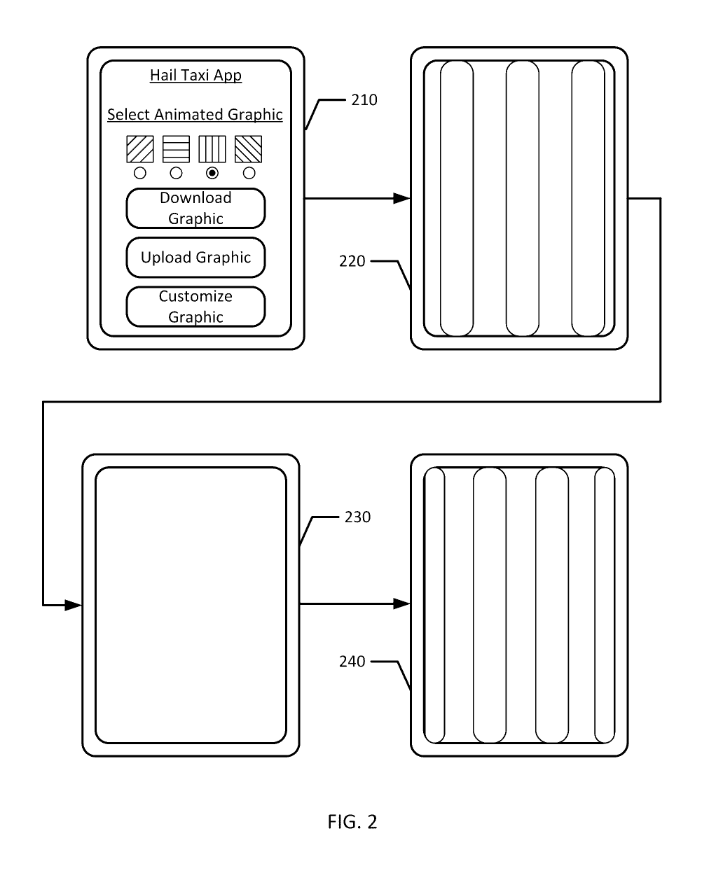

FIG. 2 illustrates a series of screenshots of a mobile device 130 providing an application 117 for hailing a taxi cab according to an example embodiment of the present disclosure. As used herein, a taxi cab may be any vehicle for hire (e.g., a traditional taxi, a bus, an Uber vehicle, a Lyft vehicle, a Haxi vehicle, a Sidecar vehicle, etc.). Screenshot 210 depicts an example embodiment of an application 117 for hailing a taxi cab as displayed on a touchscreen mobile device 130. In the example embodiment, the application 117 provides a series of selectable icons representing animation graphics for hailing a taxi cab. The application 117 may also allow a user to download additional animation graphics to the mobile device via the application server 110 by, for example, selecting an icon to “Download Graphic.” Furthermore, the application 117 may allow a user of the mobile device 130 to upload a video, image, or animation image file to be accessed by the application 117 by, for example, selecting an icon to “Upload Graphic.” In an example embodiment, the application 117 may allow a user to customize a graphic by, for example, selecting an icon to “Customize Graphic.” Customizations may include selecting a color or including text such as a taxi cab number or identifier, a reservation number or identifier, a confirmation number or identifier, a name or other identifier of the user, a name or other identifier of the taxi cab driver, a name or other identifier of the taxi cab company, a picture or image representation of the user, a picture or image representation of the driver, the destination location or address, etc. In this manner, a user is able to not only attract the attention of the driver, but also efficiently identify himself or herself to a particular taxi cab driver as the taxi cab approaches.

In an example embodiment, the animation graphic may be a flashing color or a colored siren. In an example embodiment, a color of the animation graphic matches the color of a taxi cab that the user is attempting to hail (e.g., yellow, amber, blue, brown, etc.). For example, the animation graphic may be a yellow siren or a blinking yellow screen (e.g., the entire GUI flashing the color yellow on and off). In an embodiment the animation graphic occupies anywhere from 0-100% of the GUI display. In an example embodiment, the animation graphic occupies at least 50%, 75%, or 100% of the GUI display. In an example embodiment, the application 117 displays options to the user to select a customizable size for the animation graphic. For example, the width of the graphic, speed of movement, duty cycle, color (two or more colors may be used), etc. may be customized.

Also, the mobile device 130 may display an icon to allow the user to select a sound clip to be played alone or in conjunction with the animation graphic. As with the animation graphics, the application 117 on the mobile device 130 may provide the user with options to download a sound clip from an application server 110, upload a sound clip, or customize a sound clip. In an example embodiment, the sound clip may be a whistling sound, a siren sound, the word taxi, a name or other identifier of the user, a name or other identifier of the taxi cab driver, a name or other identifier of the taxi cab company, the destination location or address, or other sound signal or file configured to alert a taxi cab.

In the illustrated example embodiment of FIG. 2, the user selects an alert siren graphic in screenshot 210. Screenshots 220, 230, and 240 are animation graphics that are displayed on the mobile device 130, via the application 117, in response to the user's selection of the animation graphic icon in screenshot 210. Screenshots 220, 230, and 240 depict an alert siren that is a bright yellow or amber color moving across the screen and configured to alert taxi cabs that the user is seeking a vehicle for hire. In an example embodiment, touching the screen once the animation graphic begins displaying will cause the mobile device 130, via the application 117, to cease displaying the animation graphic. In another example embodiment, touching the screen once the animation graphic begins displaying will cause the mobile device 130, via the application 117, to cease displaying the animation graphic and return to the home screen of the application 117 for hailing a taxi cab as depicted in screenshot 210. In yet another example embodiment, the application 117 will cause the animation graphic to display for a brief period of time such as 1, 5, 10, 15, or 20 seconds. In an example embodiment, the application 117 displays options to the user to select a customizable length of time for displaying the animation graphic upon the selection of the icon representing the animation graphic. The mobile device 130 advantageously does not require a network connection to hail a taxi cab using the animation graphic of FIG. 2. In an example embodiment, the application 117 can hail a taxi cab using an animation graphic in the absence of any connection between the mobile device 130 and a network 120.

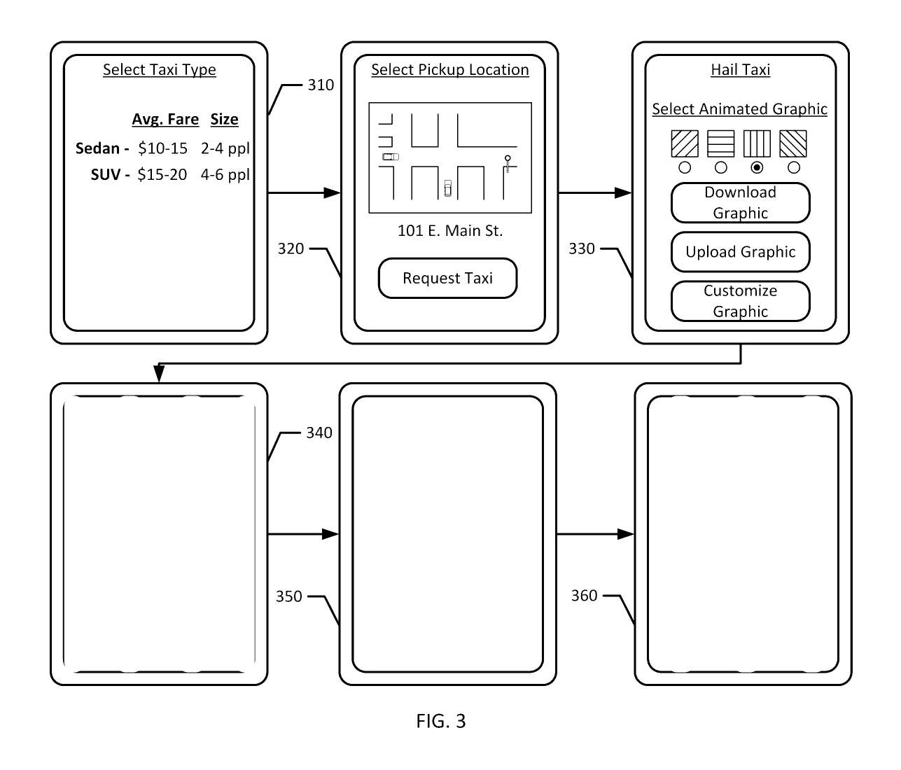

FIG. 3 illustrates a series of screenshots of a mobile device providing an plug-in application 118 for hailing a taxi cab according to an example embodiment of the present disclosure. As discussed herein, a plug-in application 118 (e.g., an extension, add-on, etc.) broadly refers to a software component or modification that adds a specific feature to an existing software application. For example, the plug-in application 118 of the present disclosure may operate in conjunction with another stand-alone taxi hailing application such as Uber, Lyft, Sidecar, or Haxi. In the illustrated example embodiment, screenshot 310 depicts a stand-alone taxi hailing application that provides a user interface including icons for a user to select a type of taxi cab (e.g., a sedan or an SUV). Screenshot 320 illustrates a second display provided by the stand-alone taxi hailing application that displays a map of the user's location, the availability and location of nearby taxi cabs, and an icon that provides the user with the option to request a taxi of choice. In an example embodiment, responsive to requesting a taxi, the plug-in application 118 of the present disclosure may cause the mobile device 130 to display a screenshot 330 similar to screenshot 210 described in greater detail with reference to FIG. 2. In addition to the features described with respect to the application 117 provided in FIG. 2, the plug-in application 118 depicted by screenshot 330 in FIG. 3 can additionally receive information from the stand-alone application such as a taxi cab number or identifier, a reservation (or confirmation) number/identifier, a name or other identifier of the user, a name or other identifier of the taxi cab driver, a name or other identifier of the taxi cab company, a picture or image representative of the user, a picture or image representative of the driver, the destination of location or address, etc. The plug-in application 118 may automatically display one or more of these pieces of information gathered by the plug-in application 118 along with the animation graphic. In another example embodiment, the plug-in application 118 may provide an interface to allow the user to select any one of these pieces of information to be displayed in conjunction with an animation graphic selected by the user. As described in greater detail with respect to screen shots 220, 230, and 240 of FIG. 2, responsive to the selection of an icon representing an animation graphic, the plug-in application 118 causes the mobile device 130 to display the animation graphic. Screenshots 340, 350, and 360 illustrate the animation graphic selected by the user.

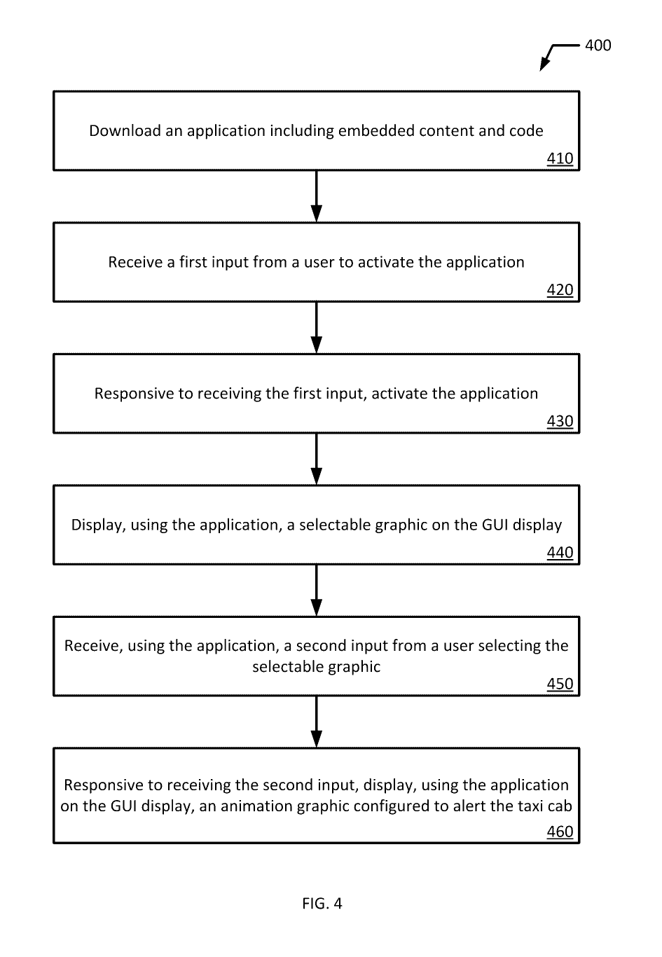

FIG. 4 illustrates a flowchart of an example method 400 for hailing a taxi cab according to an example embodiment of the present disclosure. Although the example method 400 is described with reference to the flowchart illustrated in FIG. 4, it will be appreciated that many other methods of performing the acts associated with the method 400 may be used. For example, the order of some of the blocks may be changed, certain blocks may be combined with other blocks, and some of the blocks described are optional. The method 400 may be performed by processing logic that may comprise hardware (circuitry, dedicated logic, etc.), software, or a combination of both.

The example method 400 starts and an application 117 including embedded content and code is downloaded onto the mobile device 130 (block 410). In an example embodiment, downloading an application 117 includes at least receiving the application 117 and installing the application 117 onto the mobile device 130. A user may then provide an input to the mobile device 130 to activate the application 117 (block 420). In an example embodiment the input may be selecting an icon with a physical gesture (e.g., touching the keypad, touching a button on the mobile device, touching the touchscreen, moving or shaking the mobile device, speaking a command, etc.).

Responsive to receiving the first input, the mobile device 130 activates the application 117 (block 430). The application 117 displays at least one selectable graphic on the GUI display (block 440). In an example embodiment, the selectable graphic is an icon that represents an animation graphic. In an example embodiment, the application 117 may display a plurality of selectable graphics. In an example embodiment, the application 117 may display one or more additional selectable options including the option to download a graphic for hailing a taxi cab from a server, upload a graphic for hailing a taxi cab from a memory device, customize a graphic for hailing a taxi cab, select a sound clip for hailing a taxi cab, download a sound clip for hailing a taxi cab from a server, upload a sound clip for hailing a taxi cab from a memory device, and customize a sound clip for hailing a taxi cab. The options to customize a graphic or a sound clip are described in greater detail with reference to FIG. 2 and FIG. 3.

The application 117 may then receive a second input from a user selecting the selectable graphic (block 450). In an example embodiment, the user may select the selectable graphic with a physical gesture (e.g., pressing the keypad, pressing a button on the mobile device, touching the touchscreen, moving or shaking the mobile device, speaking a command, etc.). Responsive to receiving the second input, the application 117 may cause the mobile device 130 (via the GUI display) to display an animation graphic corresponding to the selectable graphic that is configured to alert a taxi cab (block 460). In an example embodiment, the application 117 may cause the animation graphic to be displayed (and/or sound clip to be played) on the mobile device 130 by (a) receiving data from at least one of an accelerometer 160 on the mobile device 130 and a gyroscope 155 on the mobile device, (b) determining whether the data indicates that the mobile device has been lifted up in the air, and (c) responsive to determining that the mobile device has been lifted up in the air, display, using the GUI display, the animation graphic configured to alert the taxi cab. In this manner, a user can quickly and efficiently hail a taxi cab by raising the mobile device 130 in the air. In an example embodiment, the application 117 may cause the animation graphic to be displayed (and/or sound clip to be played) on the mobile device 130 by (a) receiving second data from a global positioning system (GPS) receiver 165 on the mobile device 130, (b) determining whether the second data indicates that the position of the mobile device 130 is approaching a road from a path alongside the road, and (c) responsive to determining that the position of the mobile device is approaching the road from the path alongside the road, displaying, using the application 117 on the GUI display, the animation graphic configured to alert the taxi cab. In this manner, the application 117 can automatically begin hailing the taxi cab as the user approaches the road from the sidewalk.

In an example embodiment, the application 117 provides the user with a selectable option to indicate whether the user wishes to activate the animation graphic using (a) a physical gesture, (b) raising the mobile device, (c) approaching the road, or (d) any combination thereof. For example, the application 117 may provide the user with the option to cause the animation graphic to automatically display when the user approaches the road from the sidewalk and raises the mobile device 130.

As described with reference to FIG. 2 and FIG. 3, the animation graphic may be customizable in size and color and may include additional text or images such as a taxi cab number, a reservation (or confirmation) number/identifier, a name or other identifier of the user, a name or other identifier of the taxi cab driver, a name or other identifier of the taxi cab company, a picture of the user, a picture of the driver, and/or the destination location or address. In an example embodiment, the animation graphic may be customized in this manner by the user. In another example embodiment, the animation graphic may be customized automatically by the application 117 on the mobile device 130 using data gathered or received from another application or from the application server 110.

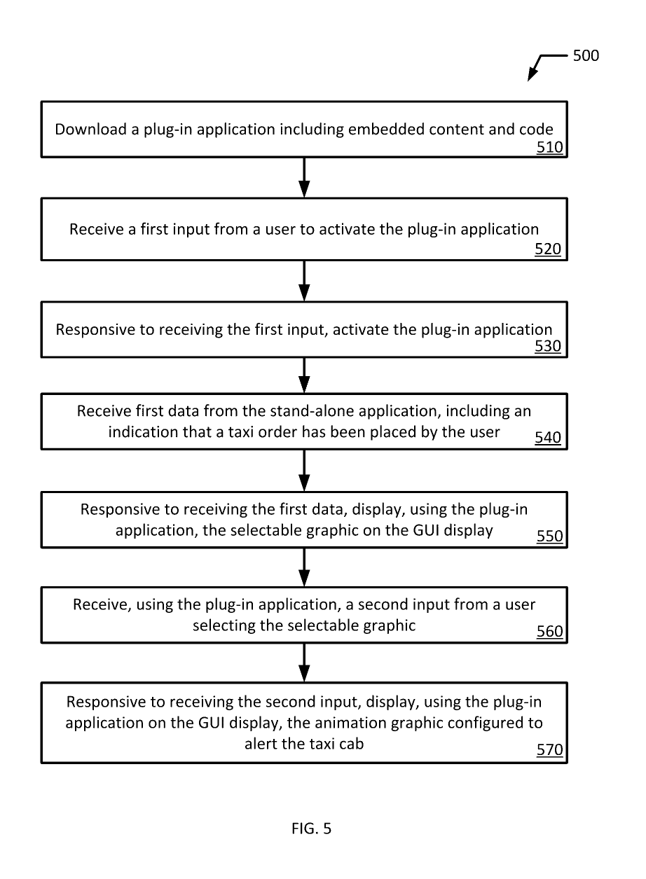

FIG. 5 illustrates a flowchart of an example method 500 for hailing a taxi cab according to an example embodiment of the present disclosure. Although the example method 500 is described with reference to the flowchart illustrated in FIG. 5, it will be appreciated that many other methods of performing the acts associated with the method 500 may be used. For example, the order of some of the blocks may be changed, certain blocks may be combined with other blocks, and some of the blocks described are optional. The method 500 may be performed by processing logic that may comprise hardware (circuitry, dedicated logic, etc.), software, or a combination of both.

The example method 500 starts and a plug-in application 118 including embedded content and code is downloaded onto the mobile device 130 (block 510). A user may then provide an input to the mobile device 130 to activate the plug-in application 118 (block 520). In an example embodiment the input may be selecting an icon with a physical gesture (e.g., pressing the keypad, pressing a button on the mobile device, touching the touchscreen, moving or shaking the mobile device, speaking a command, etc.).

Responsive to receiving the first input, the mobile device 130 activates the plug-in application 118 (block 530). In an example embodiment, a user is not required to provide an input to the mobile device 130 to activate the plug-in application 118. In an example embodiment, the plug-in application 118 activates responsive to the execution or activation of the corresponding stand-alone application for hailing taxi cabs. For example, the plug-in application 118 may operate in conjunction with the stand-alone application.

The plug-in application 118 may then receive first data from the stand-alone application including an indication that a taxi order has been placed by the user (block 540). Responsive to receiving this data, the plug-in application 118 may cause the mobile device 130 to display the selectable graphic (block 550). In an example embodiment, the plug-in application 118 may display at least the selectable graphic responsive to the activation or execution of the stand-alone application 118. In an example embodiment, the plug-in application 118 may display at least the selectable graphic responsive to detecting any input by a user on the stand-alone application.

In an example embodiment, the selectable graphic is an icon that represents an animation graphic. In an example embodiment, the plug-in application 118 may display a plurality of selectable graphics. In an example embodiment, the plug-in application 118 may display one or more additional selectable options including the option to download a graphic for hailing a taxi cab from a server, upload a graphic for hailing a taxi cab from a memory device, customize a graphic for hailing a taxi cab, select a sound clip for hailing a taxi cab, download a sound clip for hailing a taxi cab from a server, upload a sound clip for hailing a taxi cab from a memory device, and customize a sound clip for hailing a taxi cab. The options to customize a graphic or a sound clip are described in greater detail with reference to FIG. 2 and FIG. 3.

The plug-in application 118 may then receive or detect a second input from a user selecting the selectable graphic (block 560). In an example embodiment, the user may select the selectable graphic with a physical gesture (e.g., touching the keypad, touching a button on the mobile device, touching the touchscreen, moving or shaking the mobile device, speaking a command, etc.). Responsive to receiving the second input, the plug-in application 118 may cause the mobile device 130 (via the GUI display) to display an animation graphic corresponding to the selectable graphic that is configured to alert a taxi cab (block 570).

In an example embodiment, the plug-in application 118 may cause the animation graphic to be displayed (and/or sound clip to be played) on the mobile device 130 by (a) receiving data from at least one of an accelerometer 160 on the mobile device 130 and a gyroscope 155 on the mobile device, (b) determining whether the data indicates that the mobile device has been lifted up in the air, and (c) responsive to determining that the mobile device has been lifted up in the air, display, using the GUI display, the animation graphic configured to alert the taxi cab. In this manner, a user can quickly and efficiently hail a taxi cab by raising the mobile device 130 in the air. In an example embodiment, the plug-in application 118 may cause the animation graphic to be displayed (and/or sound clip to be played) on the mobile device 130 by (a) receiving second data from a GPS receiver 165 on the mobile device 130, (b) determining whether the second data indicates that the position of the mobile device 130 is approaching a road from a path alongside the road, and (c) responsive to determining that the position of the mobile device is approaching the road from the path alongside the road, displaying, using the application 118 on the GUI display, the animation graphic configured to alert the taxi cab. In this manner, the plug-in application 118 can automatically begin hailing the taxi cab as the user approaches the road from the sidewalk.

In an example embodiment, the plug-in application 118 provides the user with a selectable option to indicate whether the user wishes to activate the animation graphic using (a) a physical gesture, (b) raising the mobile device, (c) approaching the road, or (d) any combination thereof. For example, the plug-in application 118 may provide the user with the option to cause the animation graphic to automatically display when the user approaches the road from the sidewalk and raises the mobile device 130.

In an example embodiment, the plug-in application 118 may cause the animation graphic to be displayed (and/or sound clip to be played) on the mobile device 130 by (a) receiving location data from the stand-alone application and (b) responsive to determining that the taxi cab is in close proximity of the mobile device 130, displaying, using the GUI display, the animation graphic configured to alert the taxi cab. In an example embodiment, the location data includes data regarding the location of a taxi cab that has been ordered by the user of the mobile device 130 and the plug-in application 118 may calculate the proximity of the taxi cab using this location data in addition to data received from the GPS receiver 165. In an example embodiment, the location data provided by the stand-alone application directly indicates the proximity of the taxi cab from the mobile device 130 without any calculation by the plug-in application 118.

As described with reference to FIG. 2 and FIG. 3, the animation graphic may be customizable in size and color and may include additional text or images such as a taxi cab number, a reservation (or confirmation) number/identifier, a name or other identifier of the user, a name or other identifier of the taxi cab driver, a name or other identifier of the taxi cab company, a picture of the user, a picture of the driver, and/or the destination location or address. In an example embodiment, the animation graphic may be customized in this manner by the user. In another example embodiment, the animation graphic may be customized automatically by the plug-in application 118 using data gathered or received from the stand-alone application or from the application server 110.

In an example embodiment, the plug-in application 118 may receive or gather additional data from the stand-alone application including a taxi cab number or identifier, a reservation number or identifier, a confirmation number or identifier, a name or other identifier of the user, a name or other identifier of the taxi cab driver, a name or other identifier of the taxi cab company, a picture or image representation of the user, a picture or image representation of the driver, the destination location or address, the pick-up location or address, etc. The plug-in application 118 may then display one or more of these pieces of data in conjunction with the animation graphic. In an example embodiment, the plug-in application 118 provides the user with (or displays to the user) a list of information gathered or received from the stand-alone application. Responsive to the user selecting one or more items on the list, the plug-in application 118 displays the selected item or items in conjunction with the animation graphic. For example, the plug-in application 118 may cause the mobile device 130 to display (via the GUI display) an amber colored siren with a taxi reservation number.

In an example embodiment, the stand-alone application may receive data from the plug-in application 118 regarding the animation graphic that has been selected (or will be selected) by the user of the mobile device 130. The stand-alone application may then provide this information to the taxi cab driver. In this manner, the taxi cab driver can identify in advance what the keep an eye out for in picking up the user of the mobile device.

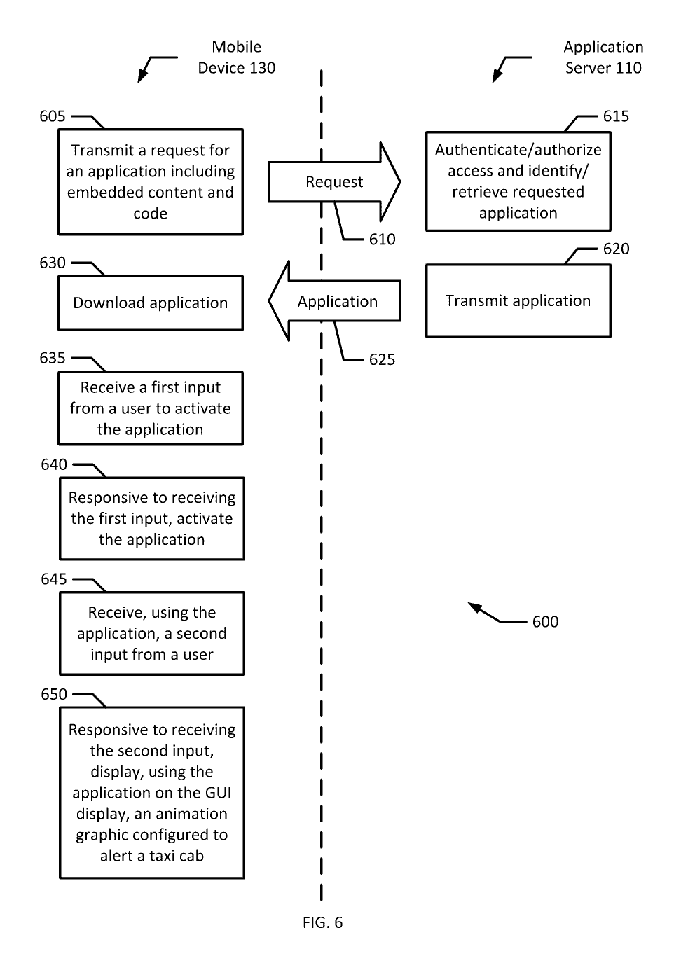

FIG. 6 illustrates a flow diagram of an example method 600 for hailing a taxi cab according to an example embodiment of the present disclosure. Although the example method 600 is described with reference to the flow diagram illustrated in FIG. 6, it will be appreciated that many other methods of performing the acts associated with the method 600 may be used. For example, the order of some of the blocks may be changed, certain blocks may be combined with other blocks, and some of the blocks described are optional. The method 600 may be performed by processing logic that may comprise hardware (circuitry, dedicated logic, etc.), software, or a combination of both.

In the illustrated example embodiment, a mobile device 130 transmits a request for an application 117 (or plug-in application 118) including embedded content and code (block 605). This request is sent to an application server 110 (block 610). The application server 110 authenticates and/or authorizes access to the mobile device 130 and identifies and retrieves the requested application (e.g., application 117 or plug-in application 118) upon authentication and/or authorization (block 615). The application server 110 then transmits the application (e.g., application 117 or plug-in application 118) to the mobile device 130 (blocks 620 and 625). The mobile device 130 downloads the application (e.g., application 117 or plug-in application 118) (block 630). The mobile device 130 receives a first input from a user to activate the application (block 635). The mobile device 130 activates the application (e.g., application 117 or plug-in application 118) responsive to receiving the first input (block 640). The mobile device 130 receives (via the application) a second input from the user (block 645). As discussed with reference to FIG. 4 and FIG. 5, an input from a user may be a physical gesture and/or the result of a calculation using inputs from a gyroscope 155, accelerometer 160, or GPS receiver 165 on the mobile device 130. Responsive to receiving the second input, the mobile device 130 displays using the application (e.g., application 117 or plug-in application 118) an animation graphic configured to alert a taxi cab.

The present disclosure offers a number of significant advantages in today's vehicle for hire environment. Public safety is of primary concern. Pedestrians (including the elderly or disabled) using the mobile device of the present disclosure can catch the attention of taxi cabs without endangering their safety by proceeding close to oncoming traffic in order to be noticed. The present disclosure accordingly serves to reduce the incidence of traffic accidents. The present disclosure also significantly increases the effectiveness of attempts to hail a taxi cab. Taxi cabs are far more likely to see a user of a mobile device of the present disclosure and their attempts to call a cab, particularly at night, on crowded streets, or in other similar conditions of poor visibility. This saves time all around and offers improved economic prospects for the vehicle for hire industry. Moreover, the convenience of providing this feature on a mobile device significantly increases these advantages by increasing the likelihood that individuals will actually use these innovative features. The various customization features of the present disclosure allow users to adapt their attempts at hailing a cab to their present circumstances. Moreover, the ability of the application of the present disclosure (e.g., application 117 or plug-in application 118) to operate in conjunction with stand-alone applications offers marked benefits including decreasing the incidence of errors in which pedestrians enter a different cab than the one he or she hired and reducing the amount of time that a cab is searching for an individual that hired it (e.g., searching on the wrong side of the street or wrong corner of an intersection). An additional benefit is that the application of the present disclosure includes two modes of operation: one in which the mobile device 130 is connected to a network 120, and one in which the mobile device 130 is not connected to a network 120. In this manner, a user of a mobile device 130 can garner the benefits of the application of the present disclosure without a network connection. For example, a user of a mobile device 130 may have maxed out the available data in his or her data plan, be in an area with poor or no service, or be unable to connect to a network. The application of the present disclosure will enable a user of a mobile device 130 to hail a taxi cab despite such conditions.

It will be appreciated that all of the disclosed methods and procedures described herein can be implemented using one or more computer programs or components. These components may be provided as a series of computer instructions on any conventional computer readable medium or machine readable medium, including volatile or non-volatile memory, such as RAM, ROM, flash memory, magnetic or optical disks, optical memory, or other storage media. The instructions may be provided as software or firmware, and/or may be implemented in whole or in part in hardware components such as ASICs, FPGAs, DSPs or any other similar devices. The instructions may be configured to be executed by one or more processors, which when executing the series of computer instructions, performs or facilitates the performance of all or part of the disclosed methods and procedures. As used in the following claims, the terms “means” and/or “step” may be used to invoke means plus function treatment under 35 U.S.C. 112(f), and means plus function treatment is not intended to be invoked unless the terms “means” or “step” are recited in the claims

Aspects of the subject matter described herein may be useful alone or in combination with one or more other aspects described herein. Without limiting the following description, in a first example aspect of the present disclosure, a system includes an application server and a mobile device, including one or more processors, a memory, a graphical user interface (GUI) display, and a speaker device, to transmit a request for an application including embedded content and code. The application server transmits the requested application to the mobile device. The mobile device downloads the application. The mobile device then receives a first input from a user to activate the application. Responsive to receiving this first input, the mobile device activates the application to (a) display a selectable graphic on the GUI display, (b) receive a second input from a user selecting the selectable graphic, and (c) responsive to receiving the second input, display on the GUI display, an animation graphic configured to alert a taxi cab.

In accordance with another example aspect of the present disclosure, which may be used in combination with any one or more of the preceding aspects, the application is further configured to receive data from at least one of an accelerometer on the mobile device and a gyroscope on the mobile device, determine whether the data indicates that the mobile device has been lifted up in the air, and responsive to determining that the mobile device has been lifted up in the air, display, using the GUI display, the animation graphic configured to alert the taxi cab.

In accordance with another example aspect of the present disclosure, which may be used in combination with any one or more of the preceding aspects, responsive to receiving the second input, the application is further configured to generate, using the speaker device, a sound signal configured to alert the taxi cab.

In accordance with another example aspect of the present disclosure, which may be used in combination with any one or more of the preceding aspects, the animation graphic occupies at least 75% of the GUI display.

In accordance with another example aspect of the present disclosure, which may be used in combination with any one or more of the preceding aspects, the animation graphic is at least one of a flashing color and a colored siren.

In accordance with another example aspect of the present disclosure, which may be used in combination with any one or more of the preceding aspects, the animation graphic includes text selected from the group consisting of a user identifier, a taxi cab identifier, a confirmation code, and text entered by the user to alert the taxi cab.

In accordance with another example aspect of the present disclosure, which may be used in combination with any one or more of the preceding aspects, the animation graphic includes text selected from the group consisting of a user identifier, a taxi cab identifier, a confirmation code, and text entered by the user to alert the taxi cab.

In accordance with another example aspect of the present disclosure, which may be used in combination with any one or more of the preceding aspects, the application is a plug-in that operates in conjunction with a stand-alone and wherein the application is further configured to receive first data from the stand-alone application, including an indication that a taxi order has been placed by the user, responsive to receiving the first data, display, using the application, the selectable graphic on the GUI display, receive, using the application, a third input from a user selecting the selectable graphic, and responsive to receiving the third input, display, using the application on the GUI display, the animation graphic configured to alert the taxi cab.

In accordance with another example aspect of the present disclosure, which may be used in combination with any one or more of the preceding aspects, the application is further configured to receive second data from a global positioning system (GPS) receiver on the mobile device, determine whether the second data indicates that the position of the mobile device is approaching a road from a path alongside the road, and responsive to determining that the position of the mobile device is approaching the road from the path alongside the road, display, using the application on the GUI display, the animation graphic configured to alert the taxi cab.

In a second example aspect of the present disclosure, a mobile device includes one or more processors, a memory, a graphical user interface (GUI) display, and a speaker device, executing instructions to download an application including embedded content and code. The mobile device receives a first input from a user to activate the application. Responsive to receiving the first input, the mobile device activates the application to (a) display a selectable graphic on the GUI display, (b) receive a second input from a user selecting the selectable graphic, and (c) responsive to receiving the second input, display on the GUI display, an animation graphic configured to alert a taxi cab.

In accordance with another example aspect of the present disclosure, which may be used in combination with any one or more of the preceding aspects, the application is further configured to receive data from at least one of an accelerometer on the mobile device and a gyroscope on the mobile device, determine whether the data indicates that the mobile device has been lifted up in the air, and responsive to determining that the mobile device has been lifted up in the air, display, using the GUI display, the animation graphic configured to alert the taxi cab.

In accordance with another example aspect of the present disclosure, which may be used in combination with any one or more of the preceding aspects, responsive to receiving the second input, the application is further configured to generate, using the speaker device, a sound signal configured to alert the taxi cab.

In accordance with another example aspect of the present disclosure, which may be used in combination with any one or more of the preceding aspects, the animation graphic occupies at least 75% of the GUI display.

In accordance with another example aspect of the present disclosure, which may be used in combination with any one or more of the preceding aspects, the animation graphic is at least one of a flashing color and a colored siren.

In accordance with another example aspect of the present disclosure, which may be used in combination with any one or more of the preceding aspects, the animation graphic includes text selected from the group consisting of a user identifier, a taxi cab identifier, a confirmation code, and text entered by the user to alert the taxi cab.

In accordance with another example aspect of the present disclosure, which may be used in combination with any one or more of the preceding aspects, the animation graphic includes text selected from the group consisting of a user identifier, a taxi cab identifier, a confirmation code, and text entered by the user to alert the taxi cab.

In accordance with another example aspect of the present disclosure, which may be used in combination with any one or more of the preceding aspects, the application is a plug-in that operates in conjunction with a stand-alone and wherein the application is further configured to receive first data from the stand-alone application, including an indication that a taxi order has been placed by the user, responsive to receiving the first data, display, using the application, the selectable graphic on the GUI display, receive, using the application, a third input from a user selecting the selectable graphic, and responsive to receiving the third input, display, using the application on the GUI display, the animation graphic configured to alert the taxi cab.

In accordance with another example aspect of the present disclosure, which may be used in combination with any one or more of the preceding aspects, the application is further configured to receive second data from a global positioning system (GPS) receiver on the mobile device, determine whether the second data indicates that the position of the mobile device is approaching a road from a path alongside the road, and responsive to determining that the position of the mobile device is approaching the road from the path alongside the road, display, using the application on the GUI display, the animation graphic configured to alert the taxi cab.

In a third example aspect of the present disclosure, an application server includes one or more processors and a memory, and provides an application for hailing a taxi cab. When the application is executed by a mobile device, it causes the mobile device to (a) display a selectable graphic on the GUI display, (b) receive a second input from a user selecting the selectable graphic, and (c) responsive to receiving the second input, display on the GUI display, an animation graphic configured to alert a taxi cab.

In accordance with another example aspect of the present disclosure, which may be used in combination with any one or more of the preceding aspects, the application is further configured to receive data from at least one of an accelerometer on the mobile device and a gyroscope on the mobile device, determine whether the data indicates that the mobile device has been lifted up in the air, and responsive to determining that the mobile device has been lifted up in the air, display, using the GUI display, the animation graphic configured to alert the taxi cab.

In accordance with another example aspect of the present disclosure, which may be used in combination with any one or more of the preceding aspects, responsive to receiving the second input, the application is further configured to generate, using the speaker device, a sound signal configured to alert the taxi cab.

In accordance with another example aspect of the present disclosure, which may be used in combination with any one or more of the preceding aspects, the animation graphic occupies at least 75% of the GUI display.

In accordance with another example aspect of the present disclosure, which may be used in combination with any one or more of the preceding aspects, the animation graphic is at least one of a flashing color and a colored siren.

In accordance with another example aspect of the present disclosure, which may be used in combination with any one or more of the preceding aspects, the animation graphic includes text selected from the group consisting of a user identifier, a taxi cab identifier, a confirmation code, and text entered by the user to alert the taxi cab.

In accordance with another example aspect of the present disclosure, which may be used in combination with any one or more of the preceding aspects, the animation graphic includes text selected from the group consisting of a user identifier, a taxi cab identifier, a confirmation code, and text entered by the user to alert the taxi cab.

In accordance with another example aspect of the present disclosure, which may be used in combination with any one or more of the preceding aspects, the application is a plug-in that operates in conjunction with a stand-alone and wherein the application is further configured to receive first data from the stand-alone application, including an indication that a taxi order has been placed by the user, responsive to receiving the first data, display, using the application, the selectable graphic on the GUI display, receive, using the application, a third input from a user selecting the selectable graphic, and responsive to receiving the third input, display, using the application on the GUI display, the animation graphic configured to alert the taxi cab.

In accordance with another example aspect of the present disclosure, which may be used in combination with any one or more of the preceding aspects, the application is further configured to receive second data from a global positioning system (GPS) receiver on the mobile device, determine whether the second data indicates that the position of the mobile device is approaching a road from a path alongside the road, and responsive to determining that the position of the mobile device is approaching the road from the path alongside the road, display, using the application on the GUI display, the animation graphic configured to alert the taxi cab.

In a fourth example aspect of the present disclosure, a method includes transmitting, by a mobile device, a request for an application including embedded content and code. Transmitting, by an application server, the requested application to the mobile device. Downloading, by the mobile device, the application. Receiving, by the mobile device, a first input from a user to activate the application. Responsive to receiving this first input, activating the application to (a) display a selectable graphic on the GUI display, (b) receive a second input from a user selecting the selectable graphic, and (c) responsive to receiving the second input, display on the GUI display, an animation graphic configured to alert a taxi cab.

In accordance with another example aspect of the present disclosure, which may be used in combination with any one or more of the preceding aspects, the application is further configured to receive data from at least one of an accelerometer on the mobile device and a gyroscope on the mobile device, determine whether the data indicates that the mobile device has been lifted up in the air, and responsive to determining that the mobile device has been lifted up in the air, display, using the GUI display, the animation graphic configured to alert the taxi cab.

In accordance with another example aspect of the present disclosure, which may be used in combination with any one or more of the preceding aspects, responsive to receiving the second input, the application is further configured to generate, using the speaker device, a sound signal configured to alert the taxi cab.

In accordance with another example aspect of the present disclosure, which may be used in combination with any one or more of the preceding aspects, the animation graphic occupies at least 75% of the GUI display.

In accordance with another example aspect of the present disclosure, which may be used in combination with any one or more of the preceding aspects, the animation graphic is at least one of a flashing color and a colored siren.

In accordance with another example aspect of the present disclosure, which may be used in combination with any one or more of the preceding aspects, the animation graphic includes text selected from the group consisting of a user identifier, a taxi cab identifier, a confirmation code, and text entered by the user to alert the taxi cab.

In accordance with another example aspect of the present disclosure, which may be used in combination with any one or more of the preceding aspects, the animation graphic includes text selected from the group consisting of a user identifier, a taxi cab identifier, a confirmation code, and text entered by the user to alert the taxi cab.

In accordance with another example aspect of the present disclosure, which may be used in combination with any one or more of the preceding aspects, the application is a plug-in that operates in conjunction with a stand-alone and wherein the application is further configured to receive first data from the stand-alone application, including an indication that a taxi order has been placed by the user, responsive to receiving the first data, display, using the application, the selectable graphic on the GUI display, receive, using the application, a third input from a user selecting the selectable graphic, and responsive to receiving the third input, display, using the application on the GUI display, the animation graphic configured to alert the taxi cab.

In accordance with another example aspect of the present disclosure, which may be used in combination with any one or more of the preceding aspects, the application is further configured to receive second data from a global positioning system (GPS) receiver on the mobile device, determine whether the second data indicates that the position of the mobile device is approaching a road from a path alongside the road, and responsive to determining that the position of the mobile device is approaching the road from the path alongside the road, display, using the application on the GUI display, the animation graphic configured to alert the taxi cab.

In a fifth example aspect of the present disclosure, a method includes receiving a first input from a user to activate an application. Responsive to receiving a first input, activating the application to (a) display a selectable graphic on the GUI display, (b) receive a second input from a user selecting the selectable graphic, and (c) responsive to receiving the second input, display on the GUI display, an animation graphic configured to alert a taxi cab.

In accordance with another example aspect of the present disclosure, which may be used in combination with any one or more of the preceding aspects, the application is further configured to receive data from at least one of an accelerometer on the mobile device and a gyroscope on the mobile device, determine whether the data indicates that the mobile device has been lifted up in the air, and responsive to determining that the mobile device has been lifted up in the air, display, using the GUI display, the animation graphic configured to alert the taxi cab.

In accordance with another example aspect of the present disclosure, which may be used in combination with any one or more of the preceding aspects, responsive to receiving the second input, the application is further configured to generate, using the speaker device, a sound signal configured to alert the taxi cab.

In accordance with another example aspect of the present disclosure, which may be used in combination with any one or more of the preceding aspects, the animation graphic occupies at least 75% of the GUI display.

In accordance with another example aspect of the present disclosure, which may be used in combination with any one or more of the preceding aspects, the animation graphic is at least one of a flashing color and a colored siren.

In accordance with another example aspect of the present disclosure, which may be used in combination with any one or more of the preceding aspects, the animation graphic includes text selected from the group consisting of a user identifier, a taxi cab identifier, a confirmation code, and text entered by the user to alert the taxi cab.

In accordance with another example aspect of the present disclosure, which may be used in combination with any one or more of the preceding aspects, the animation graphic includes text selected from the group consisting of a user identifier, a taxi cab identifier, a confirmation code, and text entered by the user to alert the taxi cab.

In accordance with another example aspect of the present disclosure, which may be used in combination with any one or more of the preceding aspects, the application is a plug-in that operates in conjunction with a stand-alone and wherein the application is further configured to receive first data from the stand-alone application, including an indication that a taxi order has been placed by the user, responsive to receiving the first data, display, using the application, the selectable graphic on the GUI display, receive, using the application, a third input from a user selecting the selectable graphic, and responsive to receiving the third input, display, using the application on the GUI display, the animation graphic configured to alert the taxi cab.

In accordance with another example aspect of the present disclosure, which may be used in combination with any one or more of the preceding aspects, the application is further configured to receive second data from a global positioning system (GPS) receiver on the mobile device, determine whether the second data indicates that the position of the mobile device is approaching a road from a path alongside the road, and responsive to determining that the position of the mobile device is approaching the road from the path alongside the road, display, using the application on the GUI display, the animation graphic configured to alert the taxi cab.

It should be understood that various changes and modifications to the example embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A system for hailing a taxi cab comprising:
an application server; and
a mobile device, including one or more processors, a memory, a graphical user interface (GUI) display, and a speaker device,
wherein the mobile device and application server cooperate to:
transmit, by the mobile device, a request for an application including embedded content and code;
responsive to receiving the request, transmit, by the application server, the application to the mobile device;
download, by the mobile device, the application;
receive, by the mobile device, a first input from a user to activate the application;
responsive to receiving the first input, activate, by the mobile device, the application to:
display, using the application, a selectable graphic on the GUI display;
receive, using the application, a second input from a user selecting the selectable graphic; and
responsive to receiving the second input, display, using the application on the GUI display, an animation graphic configured to alert the taxi cab.

2. The system of claim 1, wherein the application is further configured to:
receive data from at least one of an accelerometer on the mobile device and a gyroscope on the mobile device;
determine whether the data indicates that the mobile device has been lifted up in the air; and
responsive to determining that the mobile device has been lifted up in the air, display, using the GUI display, the animation graphic configured to alert the taxi cab.

3. The system of claim 1, wherein responsive to receiving the second input, the application is further configured to generate, using the speaker device, a sound signal configured to alert the taxi cab.

4. The system of claim 1, wherein the animation graphic occupies at least 75% of the GUI display.

5. The system of claim 1, wherein the animation graphic is at least one of a flashing color and a colored siren.

6. The system of claim 1, wherein the animation graphic includes text selected from the group consisting of a user identifier, a taxi cab identifier, a confirmation code, and text entered by the user to alert the taxi cab.

7. The system of claim 1, wherein the application is a plug-in that operates in conjunction with a stand-alone and wherein the application is further configured to:
receive first data from the stand-alone application, including an indication that a taxi order has been placed by the user;
responsive to receiving the first data, display, using the application, the selectable graphic on the GUI display;
receive, using the application, a third input from a user selecting the selectable graphic; and
responsive to receiving the third input, display, using the application on the GUI display, the animation graphic configured to alert the taxi cab.

8. The system of claim 7, wherein the application is further configured to:
receive second data from a global positioning system (GPS) receiver on the mobile device;
determine whether the second data indicates that the position of the mobile device is approaching a road from a path alongside the road; and
responsive to determining that the position of the mobile device is approaching the road from the path alongside the road, display, using the application on the GUI display, the animation graphic configured to alert the taxi cab.

9. A mobile device for hailing a taxi cab comprising:
a memory;
a graphical user interface (GUI) display;
a speaker device; and
one or more processors, wherein the one or more processors execute instructions to:
download, by the mobile device, an application including embedded content and code;
receive, by the mobile device, a first input from a user to activate the application;
responsive to receiving the first input, activate, by the mobile device, the application to:
display, using the application, a selectable graphic on the GUI display;
receive, using the application, a second input from a user selecting the selectable graphic; and
responsive to receiving the second input, display, using the application on the GUI display, an animation graphic configured to alert the taxi cab.

10. The mobile device of claim 9, wherein the application is further configured to:
receive data from at least one of an accelerometer on the mobile device and a gyroscope on the mobile device;
determine whether the data indicates that the mobile device has been lifted up in the air; and
responsive to determining that the mobile device has been lifted up in the air, display, using the GUI display, the animation graphic configured to alert the taxi cab.

11. The mobile device of claim 9, wherein responsive to receiving the second input, the application is further configured to generate, using the speaker device, a sound signal configured to alert the taxi cab.

12. The mobile device of claim 9, wherein the animation graphic occupies at least 75% of the GUI display.

13. The mobile device of claim 9, wherein the animation graphic is at least one of a flashing color and a colored siren.

14. The mobile device of claim 9, wherein the animation graphic includes text selected from the group consisting of a user identifier, a taxi cab identifier, a confirmation code, and text entered by the user to alert the taxi cab.

15. The mobile device of claim 9, wherein the application is a plug-in that operates in conjunction with a stand-alone and wherein the application is further configured to:
receive first data from the stand-alone application, including an indication that a taxi order has been placed by the user;
responsive to receiving the first data, display, using the application, the selectable graphic on the GUI display;
receive, using the application, a third input from a user selecting the selectable graphic; and
responsive to receiving the third input, display, using the application on the GUI display, the animation graphic configured to alert the taxi cab.

16. The mobile device of claim 15, wherein the application is further configured to:
receive second data from a global positioning system (GPS) receiver on the mobile device;
determine whether the second data indicates that the position of the mobile device is approaching a road from a path alongside the road; and
responsive to determining that the position of the mobile device is approaching the road from the path alongside the road, display, using the application on the GUI display, the animation graphic configured to alert the taxi cab.

17. An application server for hailing a taxi cab comprising:
one or more processors; and
a memory storing an application,
wherein the application server provides the application, which when executed on a mobile device, is configured to:
display, using the application, a selectable graphic on a GUI display of the mobile device;
receive, using the application, an input from a user selecting the selectable graphic; and
responsive to receiving the input, display, using the application on the GUI display, an animation graphic configured to alert the taxi cab.

18. The application server of claim 17, wherein the application is further configured to:
receive data from at least one of an accelerometer on the mobile device and a gyroscope on the mobile device;
determine whether the data indicates that the mobile device has been lifted up in the air; and
responsive to determining that the mobile device has been lifted up in the air, display, using the GUI display, the animation graphic configured to alert the taxi cab.

19. The application server of claim 17, wherein the application is a plug-in that operates in conjunction with a stand-alone and wherein the application is further configured to:
receive first data from the stand-alone application, including an indication that a taxi order has been placed by the user;
responsive to receiving the first data, display, using the application, the selectable graphic on the GUI display;
receive, using the application, a third input from a user selecting the selectable graphic; and
responsive to receiving the third input, display, using the application on the GUI display, the animation graphic configured to alert the taxi cab.

20. The application server of claim 19, wherein the application is further configured to:
receive second data from a global positioning system (GPS) receiver on the mobile device;
determine whether the second data indicates that the position of the mobile device is approaching a road from a path alongside the road; and
responsive to determining that the position of the mobile device is approaching the road from the path alongside the road, display, using the application on the GUI display, the animation graphic configured to alert the taxi cab.
